(19) United States
(12) Patent Application Publication
(10) Pub. No.: US 2007/0171958 A1
(43) Pub. Date: Jul. 26, 2007

(54) Electrical device measurement probes

(76) Inventors: Anh Hoang, San Jose, CA (US); Terry Stapleton, San Jose, CA (US)

Correspondence Address: JONES DAY, 222 East 41st Street, New York, NY, 10017-6702, US

(21) Appl. No.: 11/337,641

(22) Filed: Jan. 23, 2006

(51) Int. Cl. G01J 5/00; G01K 11/00

(52) U.S. Cl. 374/161; 374/131

(57) ABSTRACT

A probe for use within a high voltage and high current electrical device is disclosed. The probe comprises an optical fiber, a substrate having a slot, and a photoluminescent material. The fiber has a first and second end and is configured to convey an activation light from the first to second end. A portion of the fiber is within the slot such that the slot receives the second end of the fiber. Emission of the photoluminescent material, as a function of temperature, is known. The photoluminescent material is disposed within at least a portion of the slot that faces the second end of the fiber so that they are in optical communication with each other. A change in intensity of a luminescent light emitted back into the fiber by the photoluminescent material when the activation light is conveyed by the fiber onto the photoluminescent material provides an indication of the integrity of the electrical device.

### FIELD OF THE INVENTION

The present invention generally relates to temperature measurement probes, and more particularly to fiber optic measurement probes capable of measuring temperature in harsh environments such as those is found within utility transformers. Some embodiments of the present invention are directed to measuring the winding hot spot temperature of transformers.

### BACKGROUND OF THE INVENTION

Sealed electrical devices, such as transformers, are used in several industries including the utility industry. A transformer winding is surrounded by a paper material and sealed in a container filled with oil. During operation, the transformer generates heat that can degrade performance and decrease device lifetime. Because the container is sealed, access to the transformer is limited and it is not easy to remove the transformer for service and inspection due to environmental concerns. Therefore, once the transformer is sealed within the container, it must operate within specified tolerances.

A variety of transformer control systems are available to monitor sealed transformers and other electrical devices during operation. Such devices range from simple analog gauges to complex transformer monitoring systems that provide monitoring, control and communication functions all in one device. For example simulated Winding Hot Spot (WHS) as well as actual WHS temperatures of transformers provide information regarding safe transformer loading levels. There are three main methods for identifying the winding hot spot of a transformer: (i) simulated WHS temperature (gauge); (ii) calculation (electronic temperature monitoring); and (iii) direct measurement (fiber optic sensors).

Conventional winding temperature indicators use a capillary thermometer to measure top oil temperature, and have a small heater in them to simulate the temperature rise of the winding hot spot over the top oil temperature (“the gradient”). Current from one of the bushing CTs is passed through the heater, raising the measured temperature. The wattage output of the heater is calibrated using a resistor or other calibrating device. The capillary thermometer provides a typical accuracy of 2-3° C. and is known to deteriorate with time. Errors of 5-10° C. on site are not uncommon. To remain accurate, the system requires regular calibration and servicing. Transformer manufacturers are responsible for calibrating the heater to read correctly at full load. If the calculated gradient is accurate, the tuned system will provide good readings at full load under steady state conditions. One of the most common complaints with traditional simulated winding hot spot gauge systems is the tendency of the gauge to stick. This problem has been noted on both new and old transformers and is a cause for concern, especially when the gauge is used for cooling control where a stuck gauge can cause excessive transformer aging or transformer failure. In addition, WHS analog gauges typically do not provide temperature information in an electronic format that can be transmitted back through their Supervisory Control And Data Acquisition (SCADA) system.

The use of electronic temperature monitors (ETMs) has become the standard for many utilities, providing the needed temperature information to their SCADA systems. The most basic ETM systems operate exactly the same as a simulated WHS gauge, except that the additional temperature rise of winding hot spot over top oil is added digitally in the built-in computer, instead of thermally using a heater. Hence, they calculate the WHS instead of simulating it. More advanced systems incorporate more information, providing more precise hot spot calculations and providing many other diagnostic and communication functions.

Measurement devices based upon fiber optic temperature measurement provide the ability to directly measure the winding hot spot temperature. It is not simulated, not calculated, it is the actual temperature. The main reason that many utilities have resisted the use of fiber optics is probe breakage. When fiber optic temperature measurement was first introduced to the transformer industry, the fibers being used were quite fragile and required a relatively large bend radius. The technology has progressed since then. While the probes available today are more rugged, more improvement is needed in the art. Moreover, the probe tips of such known sensors remain fragile and require careful placement inside the transformer to ensure that the tip does not get crushed in the transformer manufacturing process.

By monitoring the temperature of such transformer hot spots, it is possible to determine whether the transformer is operating at peak efficiency and whether the electrical load on the transformer can or should be adjusted. For example, if a utility company decides to overload a transformer for a short period of time, winding hot spot temperature measurement accuracy is important. Fiber optic temperature probes using photoluminescent materials whose emission predictably varies with temperature have been used successfully to measure temperatures within transformers. Light to and from the photoluminescent material is coupled through the optical fiber to a controller/signal conditioner. The controller/signal conditioner processes the signal from the photoluminescent material and produces a temperature report. While known probes are functional, improvement is needed. Probes for detecting not only probe temperature, but also indicating material or device failure within the electrical device are needed in the art. Moreover, probes and probe tips that are less fragile are needed.

### SUMMARY OF THE INVENTION

A probe suitable for measuring temperature and/or indicating material or device failure is disclosed. The probe comprises an optical fiber, photoluminescent material and a probe holder made of materials suitable for use in devices conveying, converting or switching electrical power. The photoluminescent material is placed on or within a component or material that is typically maintained or replaced within the electrical device. The optical fiber is configured to transfer light between the photoluminescent material and its controller/signal conditioner. The photoluminescent material's optical emission varies predictably with temperature and when processed by the controller/signal conditioner yields a temperature report. As the material supporting the optical fiber or photoluminescent material degrades and changes the relative positions of the optical fiber and photoluminescent material, the intensity of light conveyed through the optical fiber will change. With an understanding of the relationship between maintenance requirements and relative light intensity, the device owner can monitor the condition of materials that eventually need maintenance. The optical fiber of the probe is surrounded over its entire length by several protective layers including a spirally-wound final jacket. The protective layers may be made permeable to oil, vapor and gases to facilitate complete penetration of high-dielectric strength transformer oil throughout.

Another aspect of the present invention provides a method of sensing the temperature and condition of an electrical device such as a transformer. An optical fiber and photoluminescent material whose optical emission varies predictably with temperature are placed within the electrical device in optical communication with each other. The optical fiber is configured to transfer light between the photoluminescent material and its controller/signal conditioner. The controller/signal conditioner processes the photoluminescent material's emission to yield a temperature report. As the material supporting the optical fiber or photoluminescent material degrades and changes the relative positions of the optical fiber and photoluminescent material, the intensity of light conveyed through the optical fiber changes. With an understanding of the relationship between maintenance requirements and relative light intensity, the device owner can monitor the condition of materials within the electrical device that eventually need maintenance.

### BRIEF DESCRIPTION OF THE DRAWINGS

These, as well as other features of the present invention, will become more apparent upon reference to the drawings wherein:

FIG. 1 is an exploded view of a temperature measurement probe, in accordance with an embodiment of the present invention.

FIG. 2 is plan view of the temperature measurement probe inserted at two locations of the transformer, in accordance with an embodiment of the present invention.

FIG. 3 is a plan view of the optical fiber from the temperature measurement probe of FIG. 1, in accordance with an embodiment of the present invention.

FIG. 4 is a cross-sectional view of the fiber tip shown in FIG. 3, in accordance with an embodiment of the present invention.

FIG. 5 is a plan view of the fiber tip shown in FIG. 4 in which the fiber tip is fixedly held with respect to a permeable spiral wrap in accordance with one embodiment of the present invention.

FIG. 6 is a plan view of the fiber tip shown in FIG. 4 in which the fiber tip is fixedly held with respect to a permeable spiral wrap in accordance with another embodiment of the present invention.

FIG. 7 is a curve illustrating, as an example, the characteristics of a phosphorous material in accordance with an embodiment of the present invention.

Like reference numerals refer to corresponding parts throughout the several views of the drawings.

### DETAILED DESCRIPTION

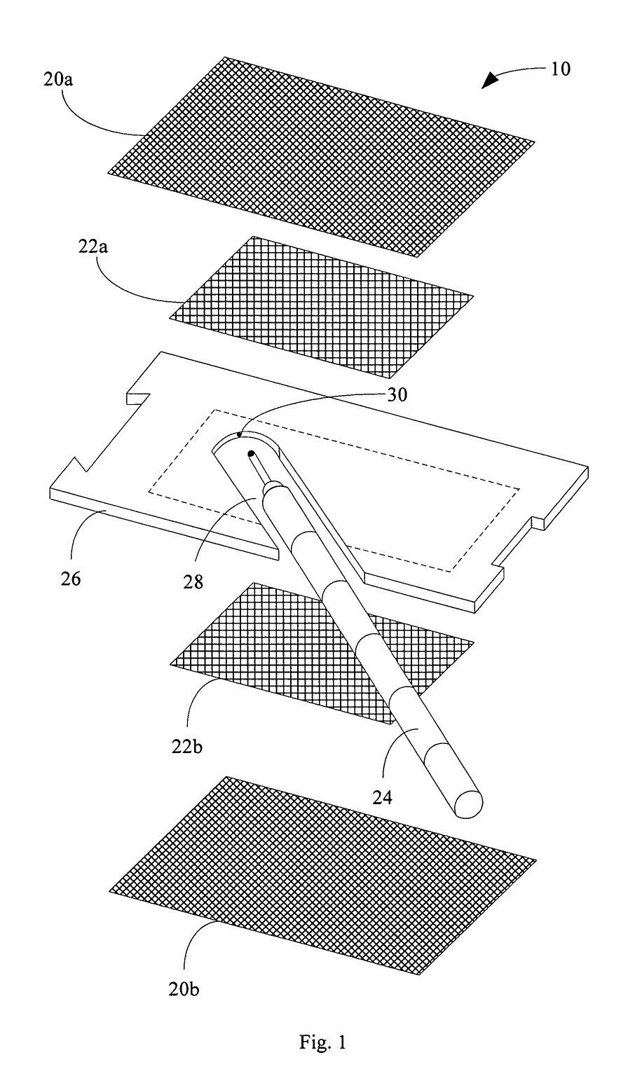

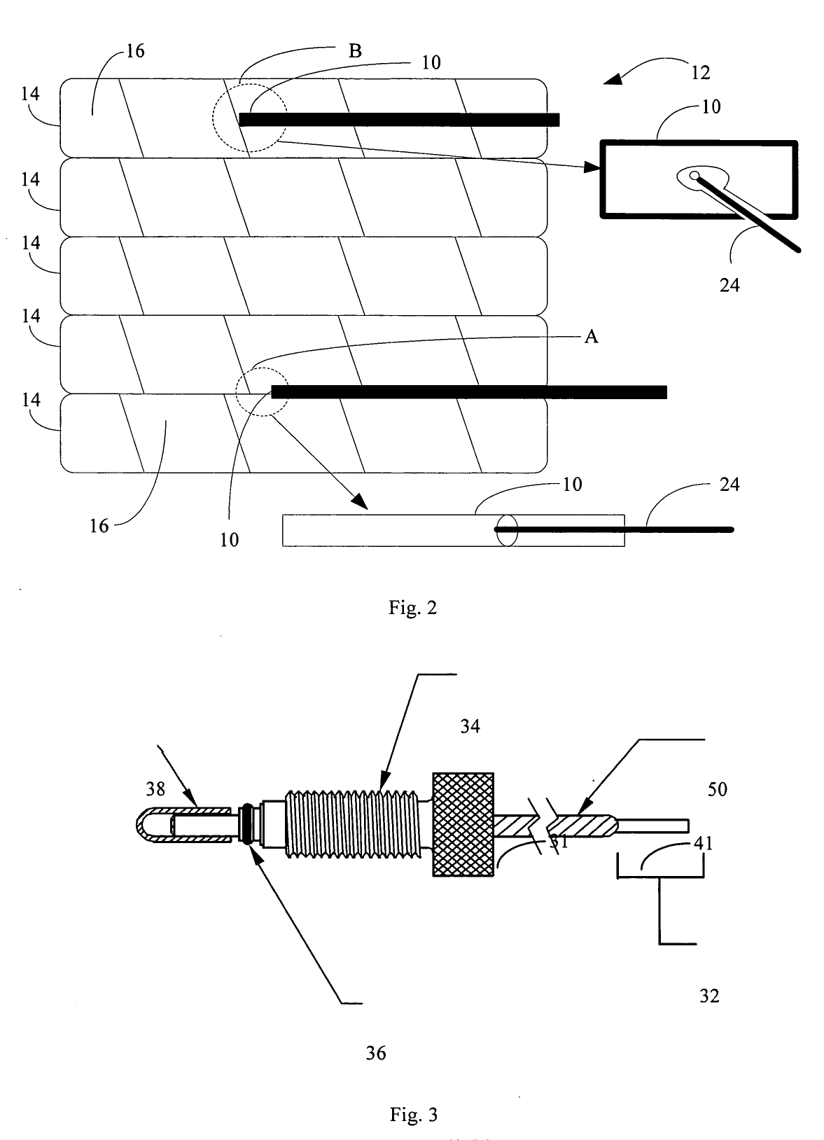

Referring now to the drawings wherein the showings are for purposes of illustrating preferred embodiments of the present invention only, and not for purposes of limiting the same, FIG. 1 is an exploded view of a fiber optic measurement probe 10 that is installed within a utility transformer. As seen in FIG. 2, transformer 12 has multiple windings 14 surrounded by insulating paper 16. The hottest spot of each winding is known as the hot spot determined by the transformer design. In some embodiments of the present invention, the probes of the present invention are placed in the vicinity of such hot spots in order to detect transformer degradation and/or to monitor hot spot temperature. In some embodiments, transformer 12 is a large transformer (e.g., greater than 100 MVA). In some embodiments, transformer 12 is a mid-size transformer (e.g., greater than 25 MVA). Probe 10 is placed between the paper 16 of adjacent windings 14 as seen in section A, or placed within the paper 16 of a single winding 14 as seen in section B. Probe 10 is placed in a location that is most likely to yield an accurate hot spot temperature reading of transformer 12.

The construction of probe 10 illustrated in FIG. 1 is designed to detect disintegration of paper 16 of transformer 12. Over time, paper 16 of transformer 12 disintegrates. However, inspection of paper 16 is difficult if not impossible because transformer 12 is sealed. When insulating paper 16 disintegrates, windings 14 of transformer 12 can short thereby causing failure of transformer 12. Probe 10 is designed to detect this disintegration of paper 16. Therefore, when probe 10 does not operate, meaning that it no longer detects a luminescent signal, it is probable that the paper 16 corresponding to probe 10 has disintegrated.

Referring back to FIG. 1, probe 10 has outer layers of paper 20a and 20b. In preferred embodiments paper 20a and 20b is a fine-grade electrically insulating paper such as, for example, rag paper (e.g., Copaco paper, Copaco-125 paper, Kraft paper). An exemplary source of such insulating paper is the Cottrell Paper Company (Rock City Falls, N.Y.). Copaco is made from one hundred percent cotton using new clippings from clothing and denim manufacturers. Paper 20a, 20b is similar to the paper that wraps windings 14 of transformer 12. Disposed adjacent to an inner side of each of the outer layers of paper 20a and 20b is a sheet of material 22a and 22b. In preferred embodiments material 22a and 22b is a sheet of GORETEX GR. Materials 22a and 22b sandwich spacer 26 (substrate) which includes a cutout 28 to receive an end of optical fiber 24. In some embodiments spacer 26 is Nomex® (Dupont) pressboard or paper (e.g., type 992, 993, or 994 Nomex pressboard). Formed within cutout 28 of spacer 26 is a hole 30 about 1 millimeter in diameter and about 1 millimeter deep. Disposed within hole 30 is a photoluminescent material whose emission varies predictably with temperature. Photoluminescent material can be inserted into hole 30 in many ways, such as by coating the photoluminescent material suspended in powder form in a binder of resin or glass directly into the hole. An appropriate glass binder is potassium silicate or Corning sealing glass. An appropriate resin is silicone hard coating material.

The end of fiber 24 is in optical communication with hole 30. In some embodiments, the end of fiber 24, bearing probe tip 32, is between 1 and 3 millimeters away from hole 30. In some embodiments fiber 24 is made of silica. In a particular embodiment, fiber 24 is 200μm silica fiber optic cable.

During operation, light is emitted from the tip of fiber 24 toward the photoluminescent material in hole 30. The wavelength range of this excitation radiation is appropriate for the particular photoluminescent material being utilized. Typically, the excitation radiation is visible or near visible light. Luminescent emission from the material is received by the tip of fiber 24 and transmitted to control electronics for processing and for determining the temperature of the material and hence transformer 12. This resultant luminescent radiation, in a visible or near visible radiation band, is usually, but not necessarily, of longer wavelength than the excitation radiation. Spacer 26 is designed to degrade over time like corresponding paper 16. When spacer 26 degrades, the photoluminescent material in hole 30 will shift or fall out resulting in a change in light intensity transmitted through fiber 24 to the controller. This failure to detect luminescence indicates that paper 16 of transformer 12 is also degrading. It is also possible to quantify such degradation based on the intensity of the light received from the photoluminescent material in hole 30. As spacer 26 degrades, the intensity of the light therefrom will lessen due to the photoluminescent material falling off of spacer 26.

Referring to FIG. 3, an assembly for fiber 24, including probe tip 32, is shown. Fiber 24 has a probe tip 32 that is supported by spacer 26. As disclosed in more detail below, a polymer outer jacket 41 circumferentially coats fiber 24 down the length of fiber 24. In preferred embodiments, polymer outer jacket 41 is permeable to oil, vapor and gases. Typically, polymer outer jacket is rendered permeable to oil, vapor and gases by perforating the jacket 41 as illustrated in FIG. 5. A flexible overlap (spiral wrap) 50 circumferentially coats the polymer outer jacket 41 down the length of fiber 24 with the exception of probe tip 32. In some embodiments, spiral wrap 50 is formed from convoluted or spiral cut fluoropolymer tubing that is wound spirally around polymer outer jacket 41. Spiral wrap 50 is wound in such a manner that gaps or spaces are formed between polymer outer jacket 41 and spiral wrap 50. Furthermore, spaces are formed between adjacent sides of polymer outer jacket 41 and spiral wrap 50 to allow oil from transformer 12 to enter the space formed between spiral wrap 50, polymer outer jacket 41, and fiber 24. Because polymer outer jacket 41 is perforated, as described in more detail in conjunction with FIG. 5, below, such oil permeates through polymer outer jacket 41 as well. By allowing oil to flow through spiral wrap 50 and polymer outer jacket 41, low dielectric strength air is displaced by high dielectric strength oil.

A coupling sleeve 34 is disposed on an end of fiber 24 opposite probe tip 32. Coupling sleeve 34 fits onto a connector that has an O-ring 36 and protective cap 38. Coupling sleeve 34 is designed to position and hold this sealing optical connector such that the optical fiber within the connector may convey light to a second optical fiber positioned to optically communicate with the probe. Light conveyed in this way ultimately reaches the appropriate signal processing electronics.

In some embodiments the appropriate signal processing electronics coupled to the probes of the present invention are configured to detect a change in the intensity of reflected light and/or the intensity of the reflected light. Such information is used by the controller to detect localized degradation in the electronic device (e.g., transformer) under observation and/or the localized temperature within the electronic device. In some embodiments, all inputs and outputs to the controller meet the requirements of the surge test of IEEE C37.90.1-2002 in which a 3000V surge is applied to all inputs and all outputs without permanent damage to the equipment.

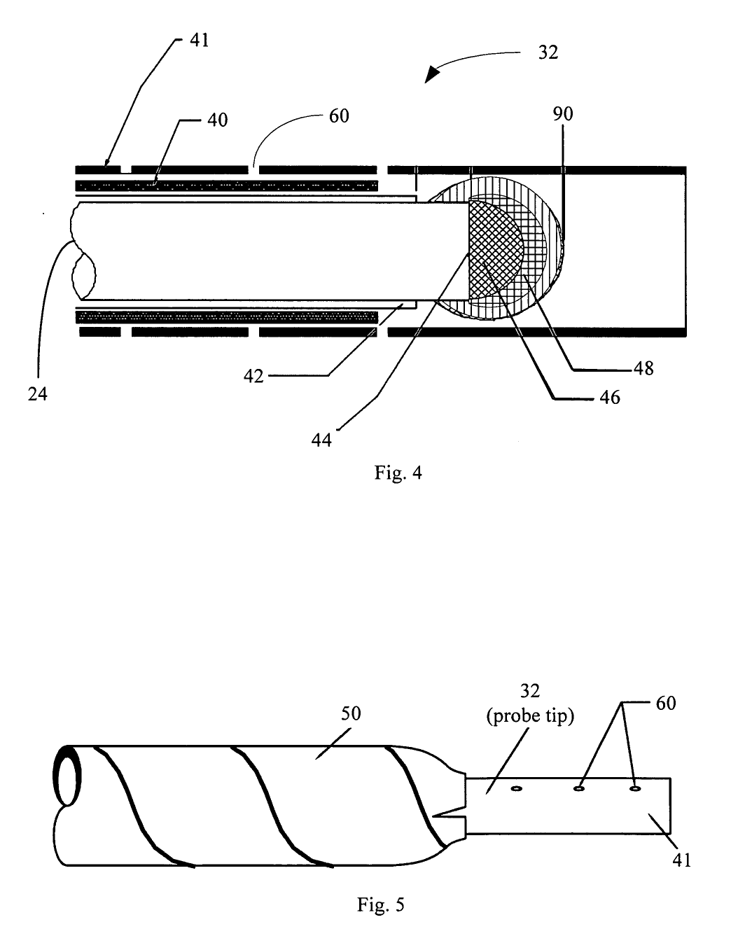

FIG. 4 illustrates another embodiment of probe tip 32. In this embodiment, photoluminescent material 46 is applied directly to end 44 of optical fiber 24 instead of to the hole 30 of spacer 26 that is illustrated in FIG. 1. In the embodiment illustrated in FIG. 4, inner jacket 42 circumferentially coats fiber 24 and serves as a protective coating. In some embodiments this inner jacket is made of polyimide. Polymer buffer (not shown) circumferentially coats inner jacket 42. In some embodiments this polymer buffer is a fluoropolymer such as PFA. A layer of Kevlar 40 circumferentially coats the polymer buffer thereby providing strength. Polymer outer jacket 41 circumferentially coats Kevlar layer 40. As illustrated in FIG. 4, polymer outer jacket 41 extends past optical fiber 24 in order to mechanically protect photoluminescent material 46. In some embodiments, polymer outer jacket 41 extends past the position of photoluminescent material 46 by 1-2 millimeters. The probe tip design illustrated in FIG. 4 is particularly advantageous because it keeps the probe tip open thereby allowing for the purging of air during probe tip installation. In preferred embodiments, polymer outer jacket 41 is rendered permeable to oil, vapor and gases by perforations 60.

The embodiment of probe tip 32 illustrated in FIG. 4 is particularly adept at measuring the temperature of an electronic device in which the probe tip is inserted. Excitation light is transmitted through optical fiber 24 and absorbed by photoluminescent material 46. In response to the excitation light, photoluminescent material 46 emits light characteristic of its temperature. This emitted light is conveyed through fiber 24 to the controller. The light emitted by photoluminescent material 46 has a different wavelength relative to that of the excitation light. Furthermore, the light emitted by photoluminescent material 46 decays overtime in a known manner as a function of the temperature of the photoluminescent material 46. Thus, by measuring the decay time of the emission light, the temperature in the vicinity of photoluminescent material 46 within an electronic device can be determined. In some embodiments, temperatures in the range of −30° C. to +200° C. can be measured using the apparatus of the present invention. As such, in some embodiments, the probes of the present invention work when completely immersed in hot transformer oil. Furthermore, in some embodiments, the temperature probes of the present invention can withstand exposure to hot kerosene vapor during the transformer insulation drying process. In some embodiments, the accuracy of such measurements is ±2° C. without calibration.

An advantage of the probe tip 32 illustrated in FIG. 4 as well as the probe tip illustrated in FIG. 1 is that no air is entrapped within the probes. For example, referring to FIG. 4, polymer outer jacket 41 includes slits and/or perforations 60 to facilitate movement of gas and fluid in and out of the assembly. Thus, for example, when probe 32 is immersed in hot oil while in vacuum, as is the case in the interior of a transformer, oil displaces air within the probe.

An end 44 of fiber 24 is highly polished and a layer of photoluminescent material 46 is applied on this end. Surrounding photoluminescent material 46 is a non-conducting optically reflective layer 48. In some embodiments, optically reflective layer 48 comprises titanium dioxide. In order to secure photoluminescent material 46 and non-conducting optically reflective layer 48 to end 44 of fiber 24, a layer of epoxy 90 is applied over both materials 46 and 48, as seen in FIG. 4.

It is desirable to fix the position of probe tip 32 relative to the end of spiral wrap 50 so that the spiral wrap will not interfere with the probe tip despite the elastic properties of the spiral wrap. One method for fixing the relative position is to weld spiral wrap 50 onto the polymer outer jacket 41 of probe tip 32. However, this is undesirable because of the risks of creating pockets of air when the probe tip is immersed in a fluid. Thus, the present invention provides alternative methods for fixing the position of probe tip 32 relative to the end of spiral wrap 50 that advantageously remove the threat of developing pockets of air when the probe tip is immersed in fluids, as in the case when the probe tip is installed in a transformer. Referring to FIG. 5, probe tip 32 may be positioned relative to the end of spiral wrap 50 at a set position beyond the end of spiral wrap 50 such that it will remain at this set position despite the elastic properties of spiral wrap 50. In the embodiment illustrated in FIG. 5, probe tip 32 is fixedly held with respect to spiral wrap 50 through the use of a reduced diameter at the end of spiral wrap 50. The reduced diameter of the spiral wrap where probe 32 emerges from spiral wrap acts as a collet to hold the probe at the desired set position. FIG. 5 illustrates how the reduced diameter is slit in such a way as to allow the reduced diameter to accept a slightly larger diameter probe 32 by allowing the diameter to expand elastically.

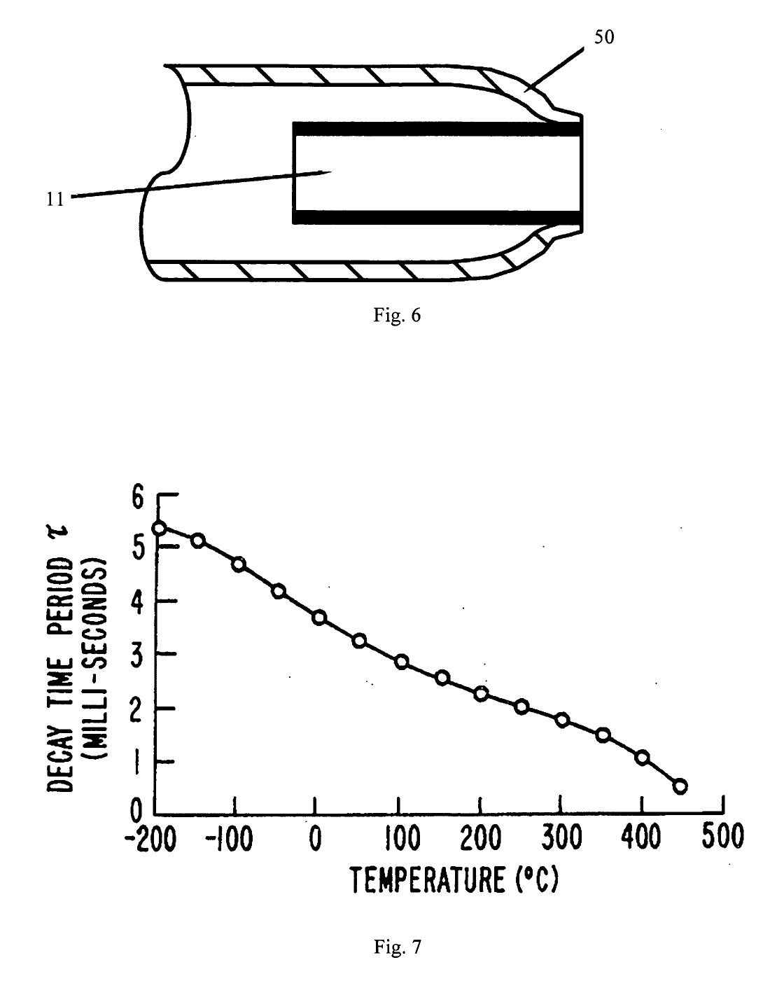

FIG. 6 illustrates another apparatus and method for fixedly holding probe 32 to a set position relative to spiral wrap 50. A polymer bushing 11 is placed between the outer surface of the probe's polymer outer jacket 41 and the inner surface of spiral wrap 50. In this embodiment, the elastic properties of the spiral wrap 50 diameter and polymer bushing 11 act as collets on probe 32. In some embodiments, bushing 11 is attached to spiral wrap 50, e.g. fused. In some embodiments, bushing 11 is not attached to spiral wrap 50.

In preferred embodiments of the present invention, probe tip 32 is advantageously open ended, thereby allowing movement of gasses and fluids throughout assembly. In this way, high-dielectric strength transformer oil can permeate the assembly. In some embodiments, sprial wrap 50 is made of a bright color to improve visibility when handling. The construction of spiral wrap 50 allows sufficient bend radius while adding a protective layer of crush resistance to the fiber optic cable. Spiral wrap 50 may stretch a bit with adjustment of tip position. However, the collet action of the spiral wrap is strong enough to overcome elastic forces of the spiral wrap. Thus, the position of probe tip 32 advantageously remains fixed relative to spiral wrap 50. The end of optical fiber 24 may also be positioned relative to the end of spiral wrap 50 using the same mechanics illustrated in FIGS. 5 and 6.

The present invention has a number of advantageous features. For instance, when used in transformers, the probes of the present invention have the advantage of increased dielectric strength because probe's polymer outer jacket 41 with slits 60 allows high dielectric transformer oil to flow between the fiber optic cable and the spriral wrap 50. Such high dielectric strength prevents the probe from creating any air pockets that can reduce dielectric strength and harm the transformer. Another advantage of the probes of the present invention is mechanical strength. Spiral wrap 50 increases protection of optical fiber 24. Optical fiber 24 is employed in a harsh environment with heavy sheet metals and larger mechanical structures. Spiral wrap 50 prevents such elements from damaging optical fiber 24. Yet another advantage is the collet of spiral wrap 50 near the distal end of optical fiber 24 because it serves as a strain relief thereby preventing probe 32 from breaking during installation of probe tip 32 into a spacer of transformer 12. Still another advantage is that the collet of spiral wrap 50 helps to hold the wrap 50 in a set position with optical fiber 24. Since about 0.5 inch of spiral wrap 50 is placed inside spacer 26 (FIG. 1), spiral wrap 50 helps to protect the distal end of probe 32 tip and helps prevent the mistake of installing the wrong end of optical fiber 24 (the proximal end of the probe) into spacer 26.

Probe 10 can be used with two optical fibers 24 to detect both degradation and temperature. For instance, the probe 10 shown in FIG. 1 could be used to detect degradation, while the fiber 24 shown in FIG. 4 can still be used to measure temperature after the probe 10 from FIG. 1 fails. It is also possible to use probe 10 to measure arcing of transformer 12. Any light produced from arcing can be transmitted by optical fiber 24 to the controlling electronics. This light can be analyzed and reported to the operator to show that the transformer is arcing.

In some embodiments, the excitation radiation that is used to excite the photoluminescent material of the embodiments shown in FIG. 1 and 4 is pulsed in the manner described in U.S. Pat. No. 4,652,143, which is hereby incorporated herein by reference in its entirety. After the excitation pulse has ended, a specific characteristic of the decaying luminescent intensity such as its decay time is measured in the manner described in U.S. Pat. No. 4,652,143. With this technique, only one wavelength band needs to be measured. In some embodiments, the entire emission band of the photoluminescent material is measured. In some embodiments, a narrower band selected from the total emission is measured. In any event, only one optical path and one spectral band need be involved for the returning signal and only one detector and one signal processing channel is required for each sensor to detect and analyze the transient data. The only requirements of such a set up is that: (1) that the decay time is truly characteristic of the sensor material and is not affected by either the intensity of excitation (within bounds) or the thermal or illumination history of the sensor, and (2) that there are no extraneous time dependent signal changes, as from stray light, which occur during the brief interval of the measurement and which alter the detected temperature signal. In some embodiments, the photoluminescent material disposed in hole 30 (FIG. 1) and/or applied directly to end 44 of optical fiber 24 as layer 46 (FIG. 4) is a phosphor made of a host of either magnesium germanate or magnesium fluorogermanate, activated with tetravalent manganese. In some embodiments, the concentration of the activator, based on starting materials, is within the range of from 0.05 to 5.0 mole percent, approximately one mole percent being preferable. The concentration of the activator controls the decay time and the intensity of luminescence. Magnesium fluorogermanate is sold commercially for use in lamps as a red color corrector in high pressure mercury lamps. A composition of a manganese activated magnesium germanate phosphor for use in the photoluminescent materials of on embodiment of the present invention is Mg₂₈Ge₁₀O₄₈ (1 mole % Mn⁺⁴). A composition of a manganese activated magnesium fluorogermanate phosphor for such use is Mg₂₈Ge_{7.5}O₃₈F₁₀(1 mole % Mn⁺⁴). The decay time of the latter phosphor as a function of its temperature is shown in FIG. 7, using an apparatus described in U.S. Pat. No. 4,652,143 hereby disclosed herein by reference, over a wide temperature range throughout which the material is useful as a temperature sensor. It will be noted that the measured decay times vary from about five milliseconds for the lower temperature of this range (about −200° C.) to about one millisecond for the higher temperature (about +400° C.), decay times which are easily measured to high accuracy by electronic techniques. The photoluminescent material disposed in hole 30 (FIG. 1) and/or applied directly to end 44 of optical fiber 24 as layer 46 (FIG. 4) in such embodiments is made up of a powder of such a phosphor. That is, rather than one or a few crystals, there are hundreds, or even thousands, of individual grains or crystallites of the size of a few microns, typically from one to ten microns, held together by an inert, transparent binder. Each grain has a temperature dependent luminescence that contributes to the total observed luminescence although the variation from cystallite to cystallite is small. These phosphor grains are preferably manufactured by a well-known dry process. A mixture of particles of the desired resulting phosphor component compounds is thoroughly mixed and blended. Any aggregates of such particles are also broken up without fracturing the particles themselves. The resulting mixture is then fired in a controlled atmosphere at a certain temperature for a set time. A description of this process is given in Butler, Fluorescent Lamp Phosphors, The Pennsylvania State University Press, particularly Sections 1.1, 1.2, and Chap. 4, particularly Section 4.6 on pp. 54-55, which is hereby incorporated herein by reference in its entirety. The growing of phosphor crystals from a liquid starting compound is not suitable for this application since the resulting crystals are not homogenous throughout. Primarily, the activator concentration is not uniform throughout such a crystal, and this results in significantly different luminescent decay times from different parts of the crystal. The luminescent decay time varies significantly as the activator concentration varies, for the same temperature. This is undesirable, so the making of the phosphor to have uniform activator concentration is important for a system that gives repeatable, accurate results in temperature measurement.

In some embodiments, the excitation radiation that is used to excite the photoluminescent material of the embodiments shown in FIG. 1 and 4 is used, and the resultant luminescent light measured, in the manner described in U.S. Pat. 4,560,286, which is hereby incorporated herein by reference in its entirety. The composition of the photoluminescent materials having suitable characteristics for hole 30 (FIG. 1) and/or applied directly to end 44 of optical fiber 24 as layer 46 (FIG. 4) in such embodiments may be represented by the generic chemical compound description AₓB_{y}C_{z}, where A represents one or more cations, B represents one or more anions, A and B together form an appropriate non-metallic host compound, and C represents one or more activator elements that are compatable with the host material. Here, x and y are small integers and z is typically in the range of a few hundredths or less. There are a large number of known existing phosphor compounds that may be selected by a trial and error process for used in such embodiments. A preferred group of elements from which the activator element C is chosen is any of the rare earth ions having an unfilled f-electron shell, all of which have sharp isolatable fluorescent emission lines of 10 angstroms bandwidth or less. Certain of these rare earth ions having comparatively strong visible or near visible emission are preferred for convenience of detecting, and they are typically in the trivalent form: praseodymium (Pr), samarium (Sm), europium (Eu), terbium (Tb), dysprosium (Dy), holmium (Ho), erbium (Er) and thulium (Tm). Other activators such as neodymium (Nd) and ytterbium (Yb) might also be useful if infra-red sensitive detectors are used. Other non-rare earth activators having a characteristic of sharp line emission which might be potentially useful in the present invention would include uranium (U) and chromium (Cr³⁺). The activator ion is combined with a compatible host material with a concentration of something less than 10 atom percent relative to the other cations present, and more usually less than 1 atom percent, depending on the particular activator elements and host compounds chosen. A specific class of compositions that might be included in the photoluminescent materials of the present invention is a rare earth phosphor having the composition RE₂O₂S:X, where RE is one element selected from the group consisting of lanthanum (La), gadolinium (Gd) and yttrium (Y), and X is one doping element selected from the group of rare earth elements listed above having a concentration in the range of 0.01 to 10.0 atom percent as a substitute for the RE element. A more typical portion of that concentration range will be a few atom percent and in some cases less than 0.1 atom percent. The concentration is selected for the particular emission characteristics desired for a given application. Such a phosphor compound may be suspended in an organic binder, a silicone resin binder or a potassium silicate binder. Certain of these binders may be the vehicle for a paint which can be maintained in a liquid state until thinly spread over a surface whose temperature is to be measured where it will dry and thus hold the phosphor on the surface in heat conductive contact with it. A specific example of such a material that is very good for many applications is europium-doped lanthanum oxysulfide (La₂O₂S:Eu) where europium is present in the range of a few atom percent down to 0.01 atom percent as a substitute for lanthanum.

In some embodiments, the phosphor measurement techniques disclosed in U.S. Pat. Nos. 4,448,547; 4,215,275; and/or 4,075493, each of which is hereby incorporated by reference in its entirety, can be used in accordance with the present invention.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A probe for use within an electrical device, the probe comprising:
a first optical fiber having a first end and a second end, the first optical fiber configured to convey a first activation light from the first end to the second end of the first optical fiber;
a substrate comprising a slot, wherein a portion of the first optical fiber is within the slot such that the slot receives the second end of the first optical fiber; and
a first photoluminescent material, whose emission as a function of temperature is known, disposed within at least a portion of the slot that faces said second end of said first optical fiber so that said second end of said first optical fiber is in optical communication with said first photoluminescent material; wherein
a change in the intensity of a second luminescent light emitted back into the first optical fiber by the first photoluminescent material when the first activation light is conveyed by the first optical fiber onto the first photoluminescent material provides an indication of the integrity of the electrical device in the vicinity of the first photoluminescent material.

2. The probe of claim 1, wherein a controller/signal conditioner is in optical communication with said first end of said first optical fiber to detect the change in the intensity of the second luminescent light and to thereby report on the integrity of the electrical device based on the change.

3. The probe of claim 1, wherein degradation of the substrate or the first photoluminescent material as a result of exposure to operating conditions within the electrical device causes the change in the intensity of the second luminescent light.

4. The probe of claim 1, wherein an inner jacket (42) circumferentially coats the first optical fiber.

5. The probe of claim 4, wherein the inner jacket (42) comprises polyimide.

6. The probe of claim 4, wherein a polymer buffer layer circumferentially coats the inner jacket (42).

7. The probe of claim 6, wherein a layer of Kevlar (40) circumferentially coats the polymer buffer layer.

8. The probe of claim 7, wherein a polymer outer jacket (41) circumferentially coats the layer of Kevlar (40).

9. The probe of claim 8, wherein the polymer outer jacket (41) is permeable to oil, vapor and gases.

10. The probe of claim 8, wherein the polymer outer jacket (41) is perforated, thereby rendering the polymer outer jacket (41) permeable to oil, vapor and gases.

11. The probe of claim 8, wherein a permeable spiral wrap (50) circumferentially coats the polymer outer jacket (41).

12. The probe of claim 11, wherein the permeable spiral wrap (50) is permeable to oil, vapor and gases thereby permitting a high-dielectric strength transformer oil to permeate said probe.

13. The probe of claim 1, wherein the substrate is sandwiched between a first layer of GORETEX GR and a second layer of GORETEX GR.

14. The probe of claim 13, wherein the first layer of GORETEX GR, the substrate, and the second layer of GORETEX GR are collectively sandwiched between a first paper and a second paper.

15. The probe of claim 14, wherein the first paper and the second paper are electrically insulating paper.

16. The probe of claim 1, further comprising:
a second optical fiber having a first end and a second end, the second optical fiber configured to convey a third activation light from the first end to the second end of the second optical fiber; wherein a portion of the second optical fiber is within the slot such that the slot receives the second end of the second optical fiber; and
a second photoluminescent material, whose emission as a function of temperature is known, disposed on the second end of said second optical fiber so that said second end of said second optical fiber is in optical communication with said second photoluminescent material; wherein
an intensity of a fourth luminescent light emitted back into the second optical fiber by the second photoluminescent material when the third activation light is conveyed by the second optical fiber onto the second photoluminescent material provides an indication of a localized temperature within the electrical device.

17. The probe of claim 16, wherein a controller/signal conditioner is in optical communication with the first end of the first optical fiber to thereby report on the integrity of the electrical device in the vicinity of the first photoluminescent material and wherein the controller/signal conditioner is in optical communication with the first end of the second optical fiber to thereby report the localized temperature of the electrical device in the vicinity of the second photoluminescent material.

18. The probe of claim 1, wherein the electrical device is an electrical transformer and the probe is positioned near a hot spot of the transformer.

19. The probe of claim 1, wherein a flexible overlap circumferentially coats a portion of the first optical fiber.

20. The probe of claim 19, wherein the flexible overlap comprises fluoropolymer tubing.

21. The probe of claim 19, wherein the flexible overlap comprises a collet that fixes a relative position of the flexible overlap to the first optical fiber.

22. A probe for use within an electrical device, the probe comprising:
an optical fiber having a first end and a second end, the optical fiber configured to convey an activation light from the first end to the second end of the optical fiber;
a substrate comprising a slot, wherein a portion of the optical fiber is within the slot such that the slot receives the second end of the optical fiber; and
a photoluminescent material, whose emission as a function of temperature is known, disposed on the second end of said optical fiber so that said second end of said optical fiber is in optical communication with said photoluminescent material; wherein
an intensity of a luminescent light emitted back into the optical fiber by the photoluminescent material when the activation light is conveyed by the optical fiber onto the photoluminescent material provides an indication of a localized temperature within the electrical device.

23. The probe of claim 22, wherein a controller/signal conditioner is in optical communication with said first end of said optical fiber to thereby report the localized temperature of the electrical device in the vicinity of the photoluminescent material.

24. The probe of claim 22, wherein an inner jacket (42) circumferentially coats the optical fiber.

25. The probe of claim 24, wherein the inner jacket (42) comprises polyimide.

26. The probe of claim 24, wherein a polymer buffer layer circumferentially coats the inner jacket (42).

27. The probe of claim 26, wherein a layer of Kevlar (40) circumferentially coats the polymer buffer layer.

28. The probe of claim 27, wherein a polymer outer jacket (41) circumferentially coats the layer of Kevlar (40).

29. The probe of claim 27, wherein the polymer outer jacket (41) is permeable to oil, vapor and gases.

30. The probe of claim 27, wherein the polymer outer jacket (41) is perforated, thereby rendering the polymer outer jacket (41) permeable to oil, vapor and gases.

31. The probe of claim 28, wherein a permeable spiral wrap (50) circumferentially coats the polymer outer jacket (41).

32. The probe of claim 31, wherein the permeable spirally wound outer jacket is permeable to oil, vapor and gases thereby permitting a high-dielectric strength transformer oil to permeate the probe.

33. The probe of claim 22, wherein a non-conducting optically reflective layer coats the photoluminescent material.

34. The probe of claim 33, wherein the non-conducting optically reflective layer comprises titanium dioxide.

35. The probe of claim 3, wherein a layer of epoxy coats the non-conducting optically reflective layer, thereby sealing the non-conducting optically reflective layer and the photoluminescent material onto the second end of the optical fiber.

36. The probe of claim 22, wherein the substrate is sandwiched between a first layer of GORETEX GR and a second layer of GORETEX GR.

37. The probe of claim 36, wherein the first layer of GORETEX GR, the substrate, and the second layer of GORETEX GR are collectively sandwiched between a first paper and a second paper.

38. The probe of claim 37, wherein the first paper and the second paper are electrically insulating paper.

39. The probe of claim 22, wherein the electrical device is an electrical transformer and the probe is positioned near a hot spot of the transformer.

40. The probe of claim 22, wherein a flexible overlap circumferentially coats a portion of the optical fiber.

41. The probe of claim 40, wherein the flexible overlap comprises fluoropolymer tubing.

42. The probe of claim 40, wherein the flexible overlap comprises a collet that fixes a relative position of the flexible overlap to the optical fiber.

43. A method of monitoring an electrical device, the method comprising:
inserting an optical fiber within the electrical device;
inserting a photoluminescent material within the electrical device in optical communication with the optical fiber; and
measuring a temperature of the electrical device in the vicinity of the photoluminescent material based upon an intensity of a light emitted from the photoluminescent material and conveyed by the optical fiber; and
monitoring degradation of the electrical device by detecting a change in intensity of the light emitted from the photoluminescent material and conveyed by the optical fiber.

44. The method of claim 43, wherein a material supporting the optical fiber or the photoluminescent material itself degrades over time thereby causing the relative positions of the optical fiber and photoluminescent material to change and thereby altering the intensity of light conveyed by the optical fiber.

45. The method of claim 43, wherein the electrical device is a transformer.
